(19) United States
(12) Patent Application Publication
(10) Pub. No.: US 2022/0113650 A1
(43) Pub. Date: Apr. 14, 2022

(54) LIGHT SOURCE DEVICE APPLICABLE TO PRINTER/COPIER AND CONTROL METHOD THEREFOR

(71) Applicant: DALIAN ZONE WIN TECHNOLOGY INCORPORATED CO., LTD, Dalian (CN)

(72) Inventors: Yong LIU, Dalian (CN); CuiYing XIE, Dalian (CN); XiangShan WU, Dalian (CN); NaiYing CUI, Dalian (CN)

(21) Appl. No.: 17/424,287

(22) PCT Filed: May 17, 2019
(86) PCT No.: PCT/CN2019/087368

§ 371 Date: Jul. 20, 2021

(30) Foreign Application Priority Data
Apr. 19, 2019 (CN) 201910319242.X

(51) Int. Cl. G03G 15/04; G03G 15/043

(52) U.S. Cl. CPC G03G 15/0409; G03G 15/043

(57) ABSTRACT

A light source device applicable to a printer/copier includes a light source, an optical circuit board, a light source support, an outer cover, and a light source control panel, wherein the light source is fixed on the light source support; the light source support and the light source are mounted in the outer cover; the light source control panel is fixed on the outer cover; the light source is connected to the light source control panel; the optical circuit board is provided at a side opposite to the light source; and the optical circuit board is fixed on the outer cover. The light source device applicable to the printer/copier of the present invention has a simple structure, and realizes data output by controlling the point corresponding switches on the optical circuit board, and effectively improves the printing and copying speed and accuracy.

### TECHNICAL FIELD

The present invention relates to the technical field of printers, copiers, etc., and in particular, to a light source device applicable to a printer, a copier, etc., and a control method thereof.

### BACKGROUND

Most of the laser printers on the market generally have a relatively requirement on the structure of the laser, and use a laser scanning unit, which combines lens combinations, as a light source, and according to the irradiation requirement of the laser scanning unit, a light ray on a corresponding position is irradiated onto a photosensitive drum of a toner cartridge assembly. The laser scanning unit consists of a motor, a prism, a combined lens, and a circuit board. The motor has a high accuracy requirement, and it has strict requirements on the surface accuracy, the curvature of each curved surface, and light transmittance of the prism and the combined lens, so that the cost of the laser is high. Moreover, due to the requirements of the prism and the combined lens, the position requirements of the photosensitive drum and the laser are also relatively strict, so that the mounting accuracy of the laser is high.

### SUMMARY

In order to solve the foregoing problems in the prior art, the present invention provides a light source device applicable to a printer/copier. The light source device has a simple structure, and does not need a high-accuracy lens combination, by controlling a light source, the points on an optical circuit board correspond to switches to realize data output, thereby effectively improving the speed and accuracy of printing and copying.

The technical solution is as follows:

A light source device applicable to a printer/copier includes a light source, an optical circuit board, a light source support, an outer cover, and a light source control panel, wherein the light source is fixed on the light source support; the light source support and the light source are mounted in the outer cover; the light source control panel is fixed on the outer cover; the light source is connected to the light source control panel; the optical circuit board is provided at one side opposite to the light source; and the optical circuit board is fixed on the outer cover.

The present invention further includes a method for controlling printing/scanning by a light source device, including the following steps.

At S1, a printer/copier converts a digital signal of a content to be printed, into an electrical signal, and outputs to an optical circuit board.

At S2, a light source emits a light point, and the light point is irradiated onto the optical circuit board.

At S3, points on the optical circuit board to which the light point is irradiated is in an ON state, and a light ray passes through the points; and other points are in an OFF state, and the light ray is blocked.

At S4, the digital signal of the content to be printed, is irradiated onto a photosensitive drum, and a photoelectric image in a unit of the light point is formed on the photosensitive drum.

Furthermore, the points on the optical circuit board are arranged in a matrix.

Furthermore, each row of the light point corresponds to a row of the points on the optical circuit board, the rotating speed of the photosensitive drum is controlled according to a printing speed, and the longitudinal distance of the light points is a multiple of the speed thereof.

The present invention has the following beneficial effects.

The light source device applicable to the printer/copier of the present invention uses a simple light source unit structure; the light emitted by the light source thereof is normally in the ON state; the light source control panel converts the digital signal of the content, which needs to be printed, into an electrical signal, and outputs it to the optical circuit board of the light source unit; the light source emits a light point; the corresponding points on the optical circuit board are in the ON state, and the light ray passes through the points; other points are unchanged and are in the OFF state; and other points are in a dark state, and the light ray is blocked. Therefore, the light source unit irradiates the digital signal of the content, which needs to be printed, onto the photosensitive drum, and then a photoelectric image using the light point as a unit is formed on the drum; the content that needs to be printed is printed on the photosensitive drum by controlling the on/off of the point on the optical circuit board, and the points on the optical circuit board correspond to the switches to realize the data output, thereby effectively improving the speed and accuracy of printing and copying.

### BRIEF DESCRIPTION OF THE DRAWINGS

FIG. 1 is a schematic diagram of a structure of the present invention.

FIG. 2 is a diagram of an optical circuit board projected in the direction of the light source of the present invention.

The reference signs in the drawings are as follows: 1—light source; 2—optical circuit board; 3—light source support; 4—outer cover; 5—light source control panel; 6—photosensitive drum; and 7—light point on the optical circuit board.

### DETAILED DESCRIPTION

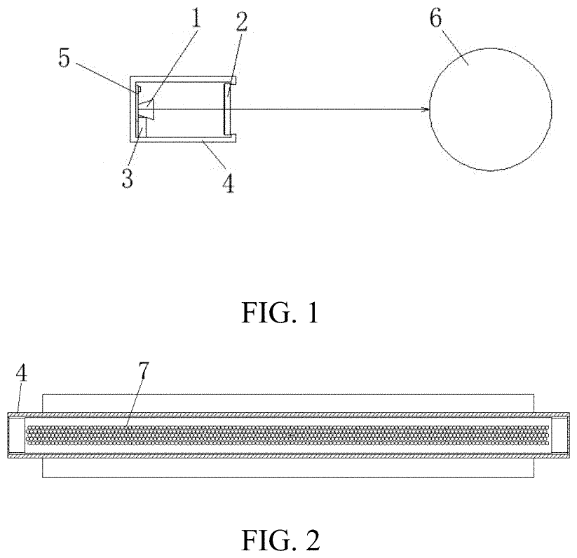

The light source device applicable to the printer/copier is further described in combination with FIGS. 1 and 2.

A light source device applicable to a printer/copier comprises a light source 1, an optical circuit board 2, a light source support 3, an outer cover 4, and a light source control panel 5, wherein the light source 1 is fixed on the light source support 3; the light source support 3 and the light source 1 are mounted in the outer cover 4; the light source control panel 5 is fixed on the outer cover 4; the light source 1 is connected to the light source control panel 5; the optical circuit board 2 is provided at one side opposite to the light source 1; and the optical circuit board 2 is fixed on the outer cover 4.

The steps of the method for controlling printing/scanning by a light source device are as follows.

At S1, a printer/copier converts a digital signal of a content, which needs to be printed, into an electrical signal, and outputs to an optical circuit board.

At S2, a light source emits a light point, and the light point is irradiated onto the optical circuit board.

At S3, points on the optical circuit board to which the light point is irradiated is in an ON state, and a light ray passes through the points; and other points are in an OFF state, and the light ray is blocked.

At S4, the digital signal of the content, which needs to be printed, is irradiated onto a photosensitive drum, and a photoelectric image in a unit of the light point is formed on the photosensitive drum.

The points on the optical circuit board are arranged in a matrix; each row of the light point corresponds to a row of the points on the optical circuit board; and the rotating speed of the photosensitive drum is controlled according to a printing speed, and the longitudinal distance of the light points is a multiple of the speed thereof.

The light source 1 in the light source unit is fixed on the light source support 3; the light source support 3 is mounted on the outer cover 4; the optical circuit board 2 is fixed on the outer cover 4; the printer converts a digital signal of an image, which needs to be printed, into an electrical signal, and outputs it to the optical circuit board 2 of the light source unit; the light source emits a corresponding light point; when the light point is irradiated onto the point on the optical circuit board 2, in this case, the corresponding points on the optical circuit board 2 are in an ON state, and the light ray passes through the points; other points are unchanged and are in an OFF state; and the other points are in a dark state, and the light ray is blocked. Therefore, the light source unit irradiates the digital signal of the content, which needs to be printed, onto the photosensitive drum 6, and a photoelectric image that uses the light point as a unit is formed on the photosensitive drum 6.

By controlling the on/off of the points on the optical circuit board 2, the content that needs to be printed is printed on the photosensitive drum 6. The optical circuit board 2 consists of points that are formed in an array matrix; these points have two states, i.e., on and off; when the points are in the on state, the points are bright and the light ray may pass through the points; when the points are in the off state, the points are dark, the light ray is blocked, and the corresponding light point subsequently is in the off state; and the content scanned by the laser is printed on the photosensitive drum 6 to complete the laser printing. Each row of light points corresponds to one row, according to the printing speed, the rotating speed of the photosensitive drum is different, and the corresponding longitudinal distance of the light points is a multiple of the speed thereof. Using multiple rows can not only compensate for the lack of points, but also speed up the printing speed.

The light source device having this novel light source control mode has a simple structure and does not need the high-accuracy lens combination, and thus reduces assembly costs and manufacturing costs. Only need to adjust and control on the software control, according to the input data, let the points on the optical circuit board correspond to the switch, then the data output can be realized, and the speed and accuracy will be greatly improved, which increases the flexibility of the design schemes such as printers and copiers, which greatly reduces the cost and manufacturing cycle.

The descriptions above are only relatively good specific implementations of the present invention. However, the scope of protection of the present application is not limited thereto. Within the technical scope disclosed by the present invention, the equivalent substitutions or changes made by any person skilled in the art according to the technical solution of the present invention and the inventive concept thereof should all fall within the scope of protection of the present invention.

1. A light source device applicable to a printer/copier, comprising a light source, an optical circuit board, a light source support, an outer cover, and a light source control panel, wherein the light source is fixed on the light source support; the light source support and the light source are mounted in the outer cover; the light source control panel is fixed on the outer cover; the light source is connected to the light source control panel; the optical circuit board is provided at a side opposite to the light source; and the optical circuit board is fixed on the outer cover.

2. A method for controlling printing/scanning by a light source device, comprising the following steps:
S1, converting, by a printer/copier, a digital signal of a content to be printed, into an electrical signal, and outputting to an optical circuit board;
S2, emitting, by a light source, a light point, and irradiating the light point onto the optical circuit board;
S3, points on the optical circuit board to which the light point is irradiated being in an ON state, and passing through the points by a light ray; other points being in an OFF state, and blocking the light ray; and
S4, irradiating the digital signal of the content to be printed, onto a photosensitive drum, and forming, on the photosensitive drum, a photoelectric image in a unit of the light point.

3. The method for controlling printing/scanning by the light source device according to claim 2, wherein the points on the optical circuit board are arranged in a matrix.

4. The method for controlling printing/scanning by the light source device according to claim 3, wherein each row of the light point corresponds to a row of the points on the optical circuit board, the rotating speed of the photosensitive drum is controlled according to a printing speed, and a longitudinal distance of the light points is a multiple of the speed thereof.
